(19) United States
(12) Patent Application Publication
(10) Pub. No.: US 2022/0126629 A1
(43) Pub. Date: Apr. 28, 2022

(54) PNEUMATIC RADIAL TIRE

(71) Applicant: The Yokohama Rubber Co., LTD., Tokyo (JP)

(72) Inventors: Asuka SUZUKI, Kanagawa (JP); Shinya HARIKAE, Kanagawa (JP)

(21) Appl. No.: 17/310,440

(22) PCT Filed: Feb. 7, 2020
(86) PCT No.: PCT/JP2020/004822

§ 371 Date: Aug. 3, 2021

(30) Foreign Application Priority Data
Feb. 7, 2019 (JP) 2019-020582

(51) Int. Cl. B60C 9/00; B60C 9/04; B60C 9/20

(52) U.S. Cl. CPC B60C 9/0007; B60C 9/0042; B60C 9/04; B60C 9/20; B60C 2009/2083; B60C 2009/0078; B60C 2009/0433; B60C 2009/0466; B60C 2009/0092

(57) ABSTRACT

In a pneumatic tire, a plurality of belt layers disposed on an outer circumferential side of a carcass layer in a tread portion are formed of steel cords each having a 1×M structure formed of a number of wire strands. The number of wire strands corresponds to one to six wire strands. A tensile modulus of elasticity of the steel cords under 5 N to 50 N load is 130 GPa or more. The steel cords are arranged inclined with respect to a tire circumferential direction to intersect each other in layers of the belt layers. The belt cover layer disposed on an outer circumferential side of the belt layers is formed of organic fiber cords having elongation of 2.0% to 4.0% under 2.0 cN/dtex load. The organic fiber cords are wound helically along the tire circumferential direction.

### TECHNICAL FIELD

The present technology relates to a pneumatic radial tire provided with a belt cover layer formed of organic fiber cords and particularly relates to a pneumatic radial tire that can improve durability while effectively reducing road noise.

### BACKGROUND ART

In pneumatic radial tires for passenger cars or small trucks, a carcass layer is mounted between a pair of bead portions, a plurality of belt layers are disposed on an outer circumferential side of the carcass layer in a tread portion, and a belt cover layer including a plurality of organic fiber cords helically wound along a tire circumferential direction is disposed on an outer circumferential side of the belt layer. Nylon fiber cords are mainly applied to the organic fiber cords used in the belt cover layer; however, in recent years, it has been proposed to use polyethylene terephthalate fiber cords (hereinafter referred to as PET fiber cords) that are highly elastic and inexpensive compared to nylon fiber cords (for example, see Japan Unexamined Patent Publication No. 2001-063312). In a case where a belt cover layer formed of such highly elastic PET fiber cords is used, the frequency of vibration generated in a pneumatic tire when traveling tends to shift into a band that is less likely to resonate with a vehicle. As a result, mid-range frequency road noise can be effectively suppressed.

On the other hand, in a case where highly elastic PET fiber cords are used in the belt cover layer, there is a risk that separation easily occurs between the belt layers and the belt cover layer due to the difference in physical properties between the PET fiber cords and reinforcing cords that constitute the adjacent belt layers (differences in elastic modulus and elongation under load). Accordingly, there is a need for a countermeasure for improving durability against separation between the belt layers and the belt cover layer while achieving the aforementioned effect of suppressing road noise by the belt cover layer (highly elastic PET fiber cords).

### SUMMARY

The present technology relates to a pneumatic radial tire provided with a belt cover layer formed of organic fiber cords and particularly relates to a pneumatic radial tire that can improve durability while effectively reducing road noise.

A pneumatic radial tire according to an embodiment of the present technology includes: a tread portion extending in a tire circumferential direction and having an annular shape; a pair of sidewall portions respectively disposed on both sides of the tread portion; and a pair of bead portions each disposed on an inner side of the sidewall portions in a tire radial direction. The pneumatic radial tire includes: a carcass layer mounted between the pair of bead portions; a plurality of belt layers disposed on an outer circumferential side of the carcass layer in the tread portion; and a belt cover layer disposed on an outer circumferential side of the belt layers. The belt layers are formed of steel cords each having a 1×M structure formed of M number of wire strands. The M number of wire strands corresponds to one to six wire strands. A tensile modulus of elasticity of the steel cords under 5 N to 50 N load is 130 GPa or more. The steel cords are arranged inclined with respect to the tire circumferential direction to intersect each other in layers of the belt layers. The belt cover layer is formed of organic fiber cords having elongation of 2.0% to 4.0% under 2.0 cN/dtex load. The organic fiber cords are wound helically along the tire circumferential direction.

In an embodiment of the present technology, by using the organic fiber cords having elongation of 2.0% to 4.0% under 2.0 cN/dtex load in the belt cover layer, the frequency of vibration generated at the pneumatic tire when traveling can be shifted to a band that is less likely to resonate with a vehicle, the mid-range frequency road noise is reduced, and thus noise performance can be improved. On the other hand, since steel cords having the structure and physical properties described above and having a small initial elongation are used as the belt layer, separation in layers between the belt layer and the belt cover layer can be effectively prevented, and durability can be improved.

In an embodiment of the present technology, a steel cord amount A calculated as the product of a cross-sectional area S (mm²) of the steel cord and a cord count E of the steel cords per 50 mm width orthogonal to a longitudinal direction of the steel cords (the number of cords per 50 mm) is preferably within a range of 5.0 to 8.0. Accordingly, the structure of the belt layer is appropriately set, and thus advantageously, separation in layers between the belt layers and the belt reinforcing layer is prevented and durability is improved.

In an embodiment of the present technology, the M number of wire strands preferably corresponds to two wire strands, and the steel cord is preferably set in a specification having a 1×2 structure. Alternatively, the M number of wire strands preferably corresponds to one wire strand, and the steel cord is preferably set in a specification having a single-wire structure. Even with any specification, the initial elongation can be effectively reduced by the structure, and thus advantageously, separation in layers between the belt layers and the belt reinforcing layer is prevented and durability is improved.

In an embodiment of the present technology, the organic fiber cords are preferably formed of polyester fibers. By using the polyester fibers as just described, road noise performance can be effectively increased by excellent physical properties (high elastic modulus) of the polyester fibers.

### BRIEF DESCRIPTION OF DRAWINGS

FIG. 1 is a meridian cross-sectional view illustrating a pneumatic radial tire according to an embodiment of the present technology.

FIG. 2 is an explanatory diagram schematically illustrating a structure of a belt cord.

### DETAILED DESCRIPTION

Configurations of embodiments of the present technology will be described in detail below with reference to the accompanying drawings.

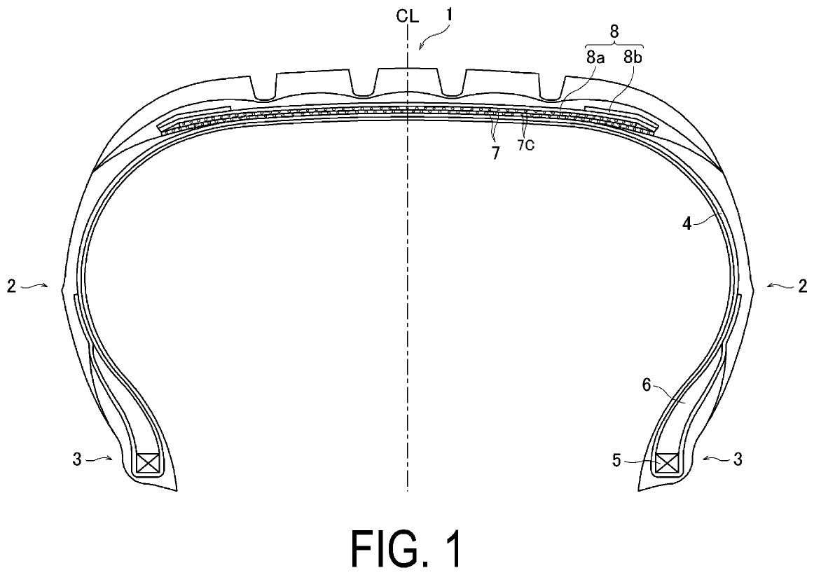

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 at an inner side in a tire radial direction. Note that “CL” in FIG. 1 denotes a tire equator. Although not illustrated in FIG. 1 as FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

In the illustrated example, a plurality of main grooves (four main grooves in the illustrated example) extending in the tire circumferential direction are formed in the outer surface of the tread portion 1; however, the number of main grooves is not particularly limited. Further, in addition to the main grooves, various grooves and sipes that include lug grooves extending in a tire width direction can be formed.

A carcass layer 4 including a plurality of reinforcing cords extending in the tire radial direction are mounted between the pair of left and right bead portions 3. A bead core 5 is embedded within each of the bead portions, and a bead filler 6 having a triangular cross-sectional shape is disposed on the outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4. For example, polyester fiber cords are preferably used as the reinforcing cords of the carcass layer 4.

A plurality (in the illustrated example, two layers) of belt layers 7 are embedded on an outer circumferential side of the carcass layer 4 in the tread portion 1. Each of the belt layers 7 includes a plurality of reinforcing cords 7C that are inclined with respect to the tire circumferential direction, and the belt layers 7 are arranged such that the reinforcing cords 7C intersect each other in the layers. In these belt layers 7, the inclination angle of the reinforcing cords 7C with respect to the tire circumferential direction is set in the range of, for example, 10° to 40°. Steel cords are used as the reinforcing cords 7C of the belt layer 7 (in the following description, “reinforcing cords 7C” may be referred to as “steel cords 7C”).

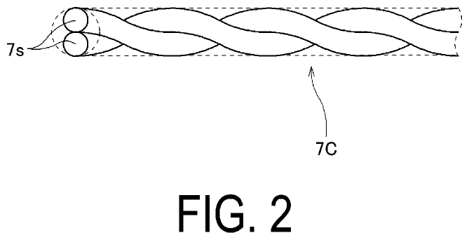

In particular, in an embodiment of the present technology, as illustrated in FIG. 2, each of the steel cords 7C constituting the belt layer 7 includes a 1×M structure (in the illustrated example, a 1×2 structure) that is formed of M number of wire strands 7s. In an embodiment of the present technology, the M number of wire strands 7s corresponds to one to six wire strands. In other words, the steel cord 7C of an embodiment of the present technology has a 1×1 structure (that is, a single-wire structure) formed of the single wire strand 7s or has a 1×M structure formed by twisting the M number of wire strands 7s (two to six wire strands) together. In particular, since an initial elongation due to the twisted structure is small and stress generated between the wire strand 7s and coating rubber thereof is small, the 1×1 structure (single-wire structure) and the illustrated 1×2 structure can be suitably employed.

Additionally, the steel cord 7C of an embodiment of the present technology has a tensile modulus of elasticity of 130 GPa or more under 5 N to 50 N load, and preferably has a tensile modulus of elasticity of 150 GPa to 200 GPa. Note that the tensile modulus of elasticity of the steel cords 7C under 5 N to 50 N load is a numerical value obtained by dividing the inclination (load/strain) in the range of 5 N to 50 N load of the load-strain curve obtained when a tensile test is performed on the steel cords 7C collected from the tire, by the sum of the cross-sectional areas of the wire strands 7s constituting the cords.

A belt cover layer 8 is provided on an outer circumferential side of the belt layer 7 for the purpose of improving high-speed durability and reducing road noise. The belt reinforcing layer 8 includes organic fiber cords oriented in the tire circumferential direction. In the belt reinforcing layer 8, the angle of the organic fiber cords with respect to the tire circumferential direction is set, for example, to from 0° to 5°. In an embodiment of the present technology, the belt cover layer 8 necessarily includes a full cover layer 8a that covers the entire region of the belt layers 7, and can be configured to include a pair of edge cover layers 8b that locally cover both end portions of the belt layers 7 as necessary (in the illustrated example, the belt cover layer includes both the full cover layer 8a and the edge cover layers 8b). The belt cover layer 8 is preferably configured such that a strip material made of at least a single organic fiber cord bunched and covered with coating rubber is wound helically in the tire circumferential direction, and desirably has, in particular, a jointless structure.

In particular, in an embodiment of the present technology, as the organic fiber cords constituting the belt cover layer 8, organic fiber cords having elongation of 2.0% to 4.0% under 2.0 cN/dtex load are used. The type of organic fibers constituting the organic fiber cords is not particularly limited, and for example, polyester fibers, nylon fibers, aramid fibers, or the like can be used. Out of the fibers, polyester fibers can be suitably used. Additionally, examples of the polyester fibers include polyethylene terephthalate fibers (PET fibers), polyethylene naphthalate fibers (PEN fibers), polybutylene terephthalate fibers (PBT), and polybutylene naphthalate fibers (PBN), and PET fibers can be suitably used. Note that in an embodiment of the present technology, the elongation under 2.0 cN/dtex load is an elongation ratio (%) of sample cords, which is measured under 2.0 cN/dtex load by conducting a tensile test in accordance with JIS (Japanese Industrial Standard)-L1017 “Test Methods for chemical fiber tire cords” and under the conditions that a length of specimen between grips is 250 mm and a tensile speed is 300±20 mm/minute.

As just described, the belt layers 7 formed of the steel cords 7C having a specific structure and specific physical properties and the belt cover layer 8 formed of organic fiber cords having specific physical properties are used in combination, and thus durability can be improved while road noise performance is improved. In other words, in the belt cover layer 8, due to the physical properties of the organic fiber cords, the frequency of vibration generated at the pneumatic tire when traveling can be shifted to a band that is less likely to resonate with a vehicle, and road noise performance can be improved. On the other hand, in the belt layers 7, the steel cords 7C having the structure and physical properties described above and having a small initial elongation are used, and thus separation in layers between the belt layers 7 and the belt cover layer 8 can be effectively prevented, and durability can be improved.

In this case, when the M number of wire strands 7s of each of the steel cords 7C constituting the belt layers 7 exceeds six wire strands, the twisted structure is not stable, and thus an initial elongation of the cord is degraded. When the tensile modulus of elasticity of the steel cords 7C constituting the belt layers 7 under 5 N to 50 N load is less than 130 GPa, an initial elongation of the steel cords 7C cannot be reduced, and the effect of preventing separation in layers between the belt layers 7 and the belt cover layer 8 cannot be achieved. When the elongation of the organic fiber cords constituting the belt cover layer 8 under 2.0 cN/dtex load is less than 2.0%, fatigue resistance of the organic fiber cords is reduced, and durability against separation in layers between the belt layers 7 and the belt cover layer 8 is reduced. When the elongation of the organic fiber cords constituting the belt cover layer 8 under 2.0 cN/dtex load exceeds 4.0%, road noise performance cannot be sufficiently improved.

When the product of a cross-sectional area S (mm²) of the steel cord 7C and a cord count E of the steel cords 7C per 50 mm width orthogonal to the longitudinal direction of the steel cords 7C (the number of cords per 50 mm) is defined as a steel cord amount A, the steel cord amount A is preferably within the range of 5.0 to 8.0. Accordingly, the structure of the belt layer is appropriately set, and thus advantageously, separation in layers between the belt layers and the belt reinforcing layer is prevented and durability is improved. When the steel cord amount A is less than 5.0, the proportion of the steel cords 7C occupied in the belt layers 7 decreases, and thus steering stability may decline. When the steel cord amount A exceeds 8.0, the effect of preventing separation in layers between the belt layers 7 and the belt cover layer 8 cannot be sufficiently achieved. The numerical range of the cross-sectional area S of the steel cord 7C or the cord count E of the steel cords 7C is not particularly limited, but the cross-sectional area S of the steel cord 7C can be set at, for example, 0.08 mm² to 0.30 mm² and the cord count E can be set at, for example, 20 cords/50 mm to 60 cords/50 mm.

When polyethylene terephthalate fiber cords (PET fiber cords) are used as the organic fiber cords constituting the belt reinforcing layer 8, PET fiber cords having an elastic modulus in a range of 3.5 cN/(tex·%) to 5.5 cN/(tex·%) under 44 N load at 100° C. is preferably used. As just described, the PET fiber cords having specific physical properties are used, and thus road noise can be effectively reduced while durability of the pneumatic radial tire is maintained successfully. When the elastic modulus of the PET fiber cords under 44 N load at 100° C. is less than 3.5 cN/(tex·%), the mid-range frequency road noise cannot be sufficiently reduced. When the elastic modulus of the PET fiber cords under 44 N load at 100° C. exceeds 5.5 cN/(tex·%), fatigue resistance of the cords decreases, and durability of the tire decreases. Note that in an embodiment of the present technology, the elastic modulus under 44 N load at 100° C. [N/(tex %)] is calculated by: conducting a tensile test with reference to “Test Methods for chemical fiber tire cords” of JIS-L1017 and under the conditions that a length of specimen between grips is 250 mm and a tensile speed is 300±20 mm/minute; and converting the inclination of the tangent, at a point corresponding to load 44 N of the load-elongation curve, to a value per 1 tex.

When polyethylene terephthalate fiber cords (PET fiber cords) are used as the organic fiber cords constituting the belt reinforcing layer 8, heat shrinkage stress of the PET fiber cords at 100° C. in addition is preferably 0.6 cN/tex or more. The heat shrinkage stress at 100° C. is set as just described, and thus road noise can be effectively reduced while durability of the pneumatic radial tire is maintained successfully. When the heat shrinkage stress of the PET fiber cords at 100° C. is less than 0.6 cN/tex, the hoop effect when traveling cannot be sufficiently improved, and it is difficult to sufficiently maintain high-speed durability. The upper limit value of the heat shrinkage stress of the PET fiber cords at 100° C. is not particularly limited, but is preferably, for example, 2.0 cN/tex. Note that in an embodiment of the present technology, the heat shrinkage stress (cN/tex) at 100° C. is heat shrinkage stress of a sample cord, which is measured with reference to “Test Methods for chemical fiber tire cords” of JIS-L1017 and when heated under the conditions of the sample length of 500 mm and the heating condition at 100° C. for 5 minutes.

In order to obtain the PET fiber cords having the aforementioned physical properties, for example, it is preferable to optimize dip processing. In other words, before a calendar process, dip processing with adhesive is performed on the PET fiber cords; however, in a normalizing process after a two-bath treatment, it is preferable that an ambient temperature is set within the range of 210° C. to 250° C. and cord tension is set in the range of 2.2×10⁻² N/tex to 6.7×10⁻² N/tex. Accordingly, desired physical properties as described above can be imparted to the PET fiber cords. When the cord tension in the normalizing process is smaller than 2.2×10⁻² N/tex, cord elastic modulus is low, and thus the mid-range frequency road noise cannot be sufficiently reduced. In contrast, when the cord tension is greater than 6.7×10⁻² N/tex, cord elastic modulus is high, and thus fatigue resistance of the cords is low.

### Examples

Tires according to Conventional Example 1, Comparative Examples 1 to 4, and Examples 1 to 10 were manufactured. In the tires having a tire size of 225/60R18 and including the basic structure as illustrated in FIG. 1, the structure of each of the steel cords constituting the belt layers; the tensile modulus of elasticity of the steel cords under 5 N to 50 N; the steel cord amount A calculated as the product of the cross-sectional area S of the steel cord and the cord count E of the steel cords per 50 mm width orthogonal to the longitudinal direction of the steel cords; the type of organic fibers used in the organic fiber cords that constitute the belt cover layer; and the elongation of the organic fiber cords under 2.0 cN/dtex load are differentiated as in Tables 1 and 2.

In any example, the belt cover layer includes a jointless structure in which a strip material made of at least a single organic fiber cord (nylon 66 fiber cord or PET fiber cord) bunched and covered with coating rubber is wound helically in the tire circumferential direction. The cord count density in the strip material is 50 cords/50 mm. In addition, each organic fiber cord (nylon 66 fiber cord or PET fiber cord) has a structure of 1100 dtex/2.

For the column of the type of organic fibers in Tables 1 and 2, nylon 66 fiber cords are indicated as “N66”, and PET fiber cords are indicated as “PET”.

As for these test tires, road noise performance, durability against separation between the belt layers and the belt cover layer, and steering stability were evaluated by the following evaluation methods, and the results are also indicated in Tables 1 and 2.

### Road Noise Performance

Each of the test tires was assembled on a wheel having a rim size of 18×7 J, mounted as front and rear wheels of a passenger vehicle (front wheel drive vehicle) having an engine displacement of 2500 cc, and inflated to an air pressure of 230 kPa, and a sound collecting microphone was placed on an inner side of the window of a driver's seat. A sound pressure level near the frequency 315 Hz was measured when the vehicle was driven at an average speed of 50 km/h on a test course of an asphalt road surface. The evaluation results were based on Conventional Example as a reference and indicated the amount of change (dB) to the reference. Note that when the amount of change is 0 dB to −1 dB, that means the effect of reducing road noise is substantially not obtained.

### Durability

Each of the test tires is mounted on a rim having a rim size of 18×7 J and held in a chamber held at room temperature 70° C. for two weeks with oxygen filled at an internal pressure of 280 kPa, and then the inside oxygen is released and air is filled at 170 kPa. Using an indoor drum testing machine having a diameter of 1707 mm, the test tires previously treated as just described were driven 5000 km for 100 hours by varying the load and slip angle with a rectangular wave of 0.083 Hz, under the conditions of an ambient temperature controlled to 38±3° C., a travel speed of 50 km/h, a slip angle within 0±3°, and a variation within 70%±40% of the JATMA (The Japan Automobile Tyre Manufacturers Association, Inc.) maximum load. After being driven, the tires were decomposed and the amount (mm) of separation in layers between the belt layers and the belt cover layer was measured. The evaluation results are indicated in three stages as below. A case where the amount of separation is 3 mm or less is “good”, a case where the amount of separation is greater than 3 mm and 5 mm or less is “pass”, and a case where the amount of separation is greater than 5 mm is “fail”. When the evaluation results are “good” or “pass”, that means sufficient durability is obtained, and “good” indicates particularly excellent durability.

### Steering Stability

The test tires were assembled on wheels having a rim size of 18×7 J, mounted as front and rear wheels of a passenger vehicle (front wheel drive vehicle) having an engine displacement of 2500 cc, and inflated to an air pressure of 230 kPa. Sensory evaluations for steering stability were made by five test drivers on a test course of a dry road surface. The evaluation results were scored by a 5-point method with the results of Conventional Example 1 being assigned 3-point (reference), and an average value of the scores of the three test drivers, with the exception of the highest point and the lowest point, was indicated. Larger points indicate superior road noise performance (sensory measurements).

TABLE 1

| | | | Conventional | Comparative | Comparative |
|---|---|---|---|---|---|
| | | | Example 1 | Example 1 | Example 2 |
| Belt | Structure of steel | | 1 × 3 × 0.28 | 1 × 3 × 0.28 | 1 × 2 × 0.30 |
| layers | cords | | | | |
| | Tensile modulus | GPa | 90 | 90 | 150 |
| | of elasticity | | | | |
| | Steel cord | | 6.3 | 6.3 | 6.0 |
| | amount A | | | | |
| Belt | Type of organic | | N66 | PET | N66 |
| cover | fibers | | | | |
| layer | Elongation under | % | 7.5 | 2.8 | 7.5 |
| | 2.0 cN/dtex load | | | | |
| Road noise performance | | dB | 0.0 | −2.0 | 0.0 |
| Durability | | | Good | Fail | Good |
| Steering stability | | | 3.0 | 3.2 | 3.0 |
| | | | Example | Example | |
| | | | 1 | 2 | Example 3 |
| Belt layers | Structure of steel cords | | 1 × 2 × 0.30 | 1 × 3 × 0.28 | 1 × 1 × 0.345 |
| | Tensile modulus of elasticity | GPa | 150 | 130 | 200 |
| | Steel cord amount A | | 6.0 | 6.3 | 6.0 |
| Belt cover | Type of organic fibers | | PET | PET | PET |
| layer | Elongation under 2.0 | % | 3.0 | 3.0 | 3.0 |
| | cN/dtex load | | | | |

| | | | | |
|---|---|---|---|---|
| Road noise performance | dB | −2.0 | −2.1 | −2.1 |
| Durability | | Good | Good | Good |
| Steering stability | | 3.2 | 3.0 | 3.0 |

TABLE 2

| | | | Comparative | Example | Example |
|---|---|---|---|---|---|
| | | | Example 3 | 4 | 5 |
| Belt layers | Structure of steel cords | | 1 × 2 × 0.30 | 1 × 2 × 0.30 | 1 × 2 × 0.30 |
| | Tensile modulus of | GPa | 150 | 150 | 150 |
| | elasticity | | | | |
| | Steel cord amount A | | 6.0 | 6.0 | 6.0 |
| Belt cover | Type of organic fibers | | PET | PET | PET |
| layer | Elongation under 2.0 | % | 1.8 | 2.2 | 3.8 |
| | cN/dtex load | | | | |
| Road noise performance | | dB | −2.5 | −2.3 | −1.5 |
| Durability | | | Fail | Pass | Good |
| Steering stability | | | 3.3 | 3.2 | 3.2 |
| | | | Comparative | Example | Example |
| | | | Example 4 | 6 | 7 |
| Belt layers | Structure of steel cords | | 1 × 2 × 0.30 | 1 × 2 × 0.30 | 1 × 2 × 0.30 |
| | Tensile modulus of | GPa | 150 | 150 | 150 |
| | elasticity | | | | |
| | Steel cord amount A | | 6.0 | 4.7 | 5.2 |
| Belt cover | Type of organic fibers | | PET | PET | PET |
| layer | Elongation under 2.0 | % | 4.3 | 3.0 | 3.0 |
| | cN/dtex load | | | | |
| Road noise performance | | dB | −0.8 | −2.1 | −2.0 |
| Durability | | | Good | Good | Good |
| Steering stability | | | 2.8 | 3.0 | 3.2 |
| | | | Example | Example | Example |
| | | | 8 | 9 | 10 |
| Belt layers | Structure of steel cords | | 1 × 2 × 0.30 | 1 × 2 × 0.30 | 1 × 2 × 0.30 |
| | Tensile modulus of | GPa | 150 | 150 | 150 |
| | elasticity | | | | |
| | Steel cord amount A | | 6.5 | 7.7 | 8.2 |
| Belt cover | Type of organic fibers | | PET | PET | PET |
| layer | Elongation under 2.0 | % | 3.0 | 3.0 | 3.0 |
| | cN/dtex load | | | | |

| | | | | |
|---|---|---|---|---|
| Road noise performance | dB | −2.0 | −2.0 | −1.5 |
| Durability | | Good | Good | Pass |
| Steering stability | | 3.2 | 3.3 | 3.5 |

As can be seen from Tables 1 and 2, in contrast to Conventional Example 1 as the reference, the tires of Examples 1 to 10 provide improved road noise performance and maintained or improved durability and steering stability. Meanwhile, in Comparative Example 1, since the tensile modulus of elasticity of the steel cords constituting the belt layers is small, separation between the belt layers and the belt cover layer cannot be prevented, and thus sufficient durability is not attained. In Comparative Example 2, since the elongation of organic fiber cords constituting the belt cover layer under 2.0 cN/dtex load is too large, the effect of improving road noise performance is not attained. In Comparative Example 3, since the elongation of the belt cover layer under 2.0 cN/dtex is too small, separation between the belt layers and the belt cover layer cannot be prevented, and thus sufficient durability is not attained. In Comparative Example 4, since the elongation of the belt cover layer under 2.0 cN/dtex load is too large, the effect of improving road noise performance is not sufficiently attained, and in addition, steering stability is declined.

1. A pneumatic radial tire, comprising:
a tread portion extending in a tire circumferential direction and having an annular shape;
a pair of sidewall portions respectively disposed on both sides of the tread portion; and,.
a pair of bead portions each disposed on an inner side of the sidewall portions in a tire radial direction,
the pneumatic radial tire comprising: a carcass layer mounted between the pair of bead portions; a plurality of belt layers disposed on an outer circumferential side of the carcass layer in the tread portion; and a belt cover layer disposed on an outer circumferential side of the belt layers,
the belt layers being formed of steel cords each having a 1×M structure formed of M number of wire strands, the M number of wire strands corresponding to one to six wire strands,
a tensile modulus of elasticity of the steel cords under 5 N to 50 N load being 130 GPa or more,
the steel cords being arranged inclined with respect to the tire circumferential direction to intersect each other in layers of the belt layers, and,
the belt cover layer being formed of organic fiber cords having elongation of 2.0% to 4.0% under 2.0 cN/dtex load, the organic fiber cords being wound helically along the tire circumferential direction.

2. The pneumatic radial tire according to claim 1, wherein a steel cord amount A calculated as the product of a cross-sectional area S (mm²) of the steel cord and a cord count E of the steel cords per 50 mm width orthogonal to a longitudinal direction of the steel cords (the number of cords per 50 mm) is within a range of 5.0 to 8.0.

3. The pneumatic radial tire according to claim 1, wherein the M number of wire strands correspond to two wire strands, and,
the steel cord has a 1×2 structure.

4. The pneumatic radial tire according to claim 1, wherein the M number of wire strands corresponds to one wire strand, and,
the steel cord has a single-wire structure.

5. The pneumatic radial tire according to claim 1, wherein the organic fiber cords are formed of polyester fibers.

6. The pneumatic radial tire according to claim 2, wherein the M number of wire strands correspond to two wire strands, and,
the steel cord has a 1×2 structure.

7. The pneumatic radial tire according to claim 6, wherein the organic fiber cords are formed of polyester fibers.

8. The pneumatic radial tire according to claim 2, wherein the M number of wire strands corresponds to one wire strand, and,
the steel cord has a single-wire structure.

9. The pneumatic radial tire according to claim 8, wherein the organic fiber cords are formed of polyester fibers.
